(19) United States
(12) Patent Application Publication
(10) Pub. No.: US 2023/0144833 A1
(43) Pub. Date: May 11, 2023

(54) 3D OBJECT PORE DENSITY REDUCTION

(71) Applicants: HEWLETT-PACKARD DEVELOPMENT COMPANY, L.P., Spring, TX (US); NANYANG TECHNOLOGICAL UNIVERSITY, Singapore (SG)

(72) Inventors: Jayaraj Radhakrishnan, Singapore (SG); Punit Kumar, Singapore (SG); Alexis Bryl, Corvallis, OR (US); Soo Seong Gan, Singapore (SG); James McKinnell, Corvallis, OR (US); Ramamurty Upadrasta, Singapore (SG)

(21) Appl. No.: 17/524,283

(22) Filed: Nov. 11, 2021

(51) Int. Cl. B30B 11/00; B22F 3/15; B30B 15/34

(52) U.S. Cl. CPC B30B 11/002; B22F 3/15; B30B 15/34; B33Y 80/00

(57) ABSTRACT

In one example in accordance with the present disclosure, a system is described. The system includes a hot isostatic pressing system. The hot isostatic pressing system includes a pressure vessel to receive an additively manufactured 3D steel object and a pressure source to apply isostatic pressure to the 3D steel object disposed therein. The isostatic pressing system also includes a heater to heat the 3D steel object while in the pressure vessel. The system also includes a controller. The controller 1) determines characteristics of the 3D steel object, 2) determines, a temperature, pressure, and duration for isostatically treating the 3D steel object, and 3) activates the pressure source and heater to apply a determined pressure and temperature to the 3D steel object based on determined characteristics of the 3D steel object.

### BACKGROUND

Additive manufacturing systems produce three-dimensional (3D) objects by building up layers of material. Some additive manufacturing systems use inkjet or other printing technology to apply some of the manufacturing materials. Additive manufacturing systems make it possible to convert a computer-aided design (CAD) model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a diagram of a system for reducing pore density in an additively manufactured 3D steel object, according to an example of the principles described herein.

FIG. 2 is a flow chart of a method for reducing pore density in an additively manufactured 3D steel object, according to an example of the principles described herein.

FIGS. 3A and 3B are graphs depicting a porosity of 3D steel objects treated as described in the method, according to an example of the principles described herein.

FIGS. 4A-4C are graphs depicting physical properties of 3D steel objects treated as described in the method, according to an example of the principles described herein.

FIGS. 5A-5C are graphs depicting physical properties of 3D steel objects treated as described in the method, according to an example of the principles described herein.

FIG. 6 is a flow chart of a method for reducing pore density in an additively manufactured 3D steel object, according to an example of the principles described herein.

FIG. 7 depicts a non-transitory machine-readable storage medium for reducing pore density in an additively manufactured 3D steel object, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing systems form a three-dimensional (3D) object through the solidification of layers of build material. Additive manufacturing systems make objects based on data in a 3D model of the object generated, for example, with a computer-aided design (CAD) computer program product. The model data is processed into slices, each slice defining portions of a layer of build material that are to be solidified.

In one particular example, a powder build material is deposited and a binding agent is selectively applied to the layer of powder build material. The binding agent is deposited in a pattern of a slice of a 3D object to be printed. This process is repeated per layer until the 3D object is formed. Such a binding-agent-based system may be used to generate metallic or ceramic 3D objects.

With a 3D object formed, the binding agent is cured to form a “green” 3D object. Cured binding agent holds the build material of the green object together. The binding agent is activated or cured by heating the object. Heating to form the cured green object may take place at a temperature that is capable of activating (or curing) the binder of the binding agent, but that does not thermally decompose the binder. When activated or cured, the binding agent glues the powder build material particles into the cured green object shape. The cured green object has enough mechanical strength that it is able to withstand extraction from the build material platform without being deleteriously affected (e.g., the shape is not lost).

The green 3D object may then be placed in an oven to further heat the green 3D object to sinter the build material to form the finished 3D object. Specifically, the binding agent is removed and the temperature is further raised such that sintering of the powder metal particles occurs to form a 3D object.

While in the oven, further heat is applied to sinter the 3D object thereby increasing its densification to at least about 95 percent densification, in some examples. In some examples, such sintering temperatures may range between about 1000 degrees Celsius to about 1500 degrees Celsius. It is to be understood that the term “green” does not connote color, but rather indicates that the part is not yet fully processed.

In yet another example, a laser, or other power source is selectively aimed at a powder build material, or a layer of a powder build material, to form a slice of a 3D printed object. Such a process may be referred to as selective laser melting where portions of the powder material, which may be metallic, are selectively melted together to form a slice of a 3D printed part.

In one particular example of additive manufacturing referred to as laser fusion, an array of lasers scans each layer of powdered build material to form a slice of a 3D printed object. In this example, each laser beam is turned on and off dynamically during the scanning process according to the image slice. Similar to a fusing agent-based system, this laser fusion process is also layer-by-layer.

While such additive manufacturing operations have greatly expanded manufacturing and development possibilities, further development may make additive manufacturing a part of even more industries. For example, some additive manufacturing operations result in 3D objects with pores of empty space within a material matrix. These pores affect the mechanical strength and integrity of the 3D object. 3D steel objects formed with a binding-agent based system may have a high-volume fraction of pores which may be difficult to eliminate and which may lead to grain growth. Porosity at high levels may result in a reduction in the fatigue resistance of the 3D object which may lead to unpredictable failure of the 3D objects during use.

As a specific example, SS17-4PH steel objects formed with a binder jet printer (BJP) had an observed porosity of 4.1±0.22%, which resulted in a fatigue strength of between 275-325 megapascals (MPa), which is less than half of the fatigue strength of SS17-4PH steel parts manufactured using other methods, i.e., not additively manufactured. That is, the tensile and fatigue properties of BJP SS17-4PH steel parts have properties similar to powder metallurgy processed SS17-4PH. This has inhibited the widespread adoption of BJP parts in engineering applications.

Accordingly, the present specification describes a method and system for reducing the porosity in additively manufactured objects such that the tensile and fatigue strength are increased, thus making additive manufacturing of steel objects feasible in a variety of applications. Specifically, to further reduce the porosity and enhance the mechanical properties, a BJP 3D steel object is subjected to a hot isostatic pressing treatment prior to an ageing treatment. That is, the 3D steel object is subjected to isostatic pressure and increased temperatures to reduce the density and size of pores in the 3D steel object. By doing so, the negative characteristics of a BJP 3D steel object may be alleviated or removed.

The hot isostatic pressing operation yielded significant benefits by increasing the strength of a BJP formed 3D steel object. For example, as described above SS17-4PH steel objects that were binder jet printed had an observed porosity of 4.1±0.22%. Using the present system, i.e., hot isostatic pressing following a binder-jet printing operation, 3D steel objects had a porosity of between 2-3%. However, this porosity was still higher than porosity measurements of other manufactured objects that had been treated with hot isostatic pressing. Despite the porosity in the hot isostatically pressed binder jet printed objects being higher than the porosity of SLM manufactured 3D steel objects, high fatigue strength (in some examples more than 500 MPa) was observed in the binder jet printed steel objects formed using the hot isostatic pressing operations described herein. That is, the combination of an additively manufacturing operation to form the 3D steel object and hot isostatic pressing achieved a resulting increase in mechanical properties beyond what would be predicted based on the resulting porosity. However, the present specification describes such an increase in mechanical strength.

Moreover, it has been shown that a hot isostatic pressing treatment on an SLM fabricated steel object reduced the fatigue strength of the 3D steel object. Accordingly, the present specification describes controlling the temperature range of the hot isostatic pressing operation to initiate the formation of carbides and restrict the excessive grain growth which was observed in the reduced-strength SLM fabricated steel objects.

Specifically, the present specification describes a system. The system includes a hot isostatic pressing system. The hot isostatic pressing system includes a pressure vessel to receive the additively manufactured 3D steel object, a pressure source to apply isostatic pressure to the 3D steel object disposed therein, and a heater to heat the 3D steel object while in the pressure vessel. The system also includes a controller. The controller determines characteristics of the 3D steel object and determines, a temperature, pressure, and duration for isostatically treating the 3D steel object. The controller also activates the pressure source and heater to apply a determined pressure and temperature to the 3D steel object based on determined characteristics of the 3D steel object.

The present specification also describes a method. According to the method, an additively manufactured 3D steel object is introduced into a pressure vessel. The pore density of the 3D steel object is reduced by 1) applying hydrostatic pressure to the 3D steel object in the pressure vessel and 2) heating the 3D steel object in the pressure vessel to a first temperature for a first duration of time. The 3D steel object is solution annealed and also aged at a second temperature for a second duration of time.

The present specification also describes a non-transitory machine-readable storage medium encoded with instructions executable by a processor of an electronic device. The machine-readable storage medium includes instructions to, when executed by the processor, cause the processor to determine characteristics of the 3D steel object and determine, a temperature, pressure, and duration for isostatically treating the 3D steel object. The machine-readable storage medium also includes instructions to, when executed by the processor, cause the processor to reduce pore density in the 3D steel object by 1) activating a pressure source to apply hydrostatic pressure to the 3D steel object in a pressure vessel and 2) activating a heater to heat the 3D steel object in the pressure vessel to a first temperature for a first duration of time. The machine-readable storage medium also includes instructions to, when executed by the processor, cause the processor to age the 3D steel object at a second temperature for a second duration of time.

As described above, the pores of additively manufactured objects, may be “open” meaning that the pores are interconnected. Open porosity occurs in powder metallurgy materials when the porosity exceeds 7%. By comparison, closed porosity occurs when the porosity is less than 5%. For porosities between 5% and 7%, whether the porosity is opened or closed is dependent upon the powder shape and size distribution.

Accordingly, such systems and methods 1) provide an additively manufactured steel object with increased tensile strength, ductility, and fatigue strength as compared to other additively manufactured steel objects; 2) have equiaxed grains free from residual stress; and 3) quickly produce such additively manufactured steel objects.

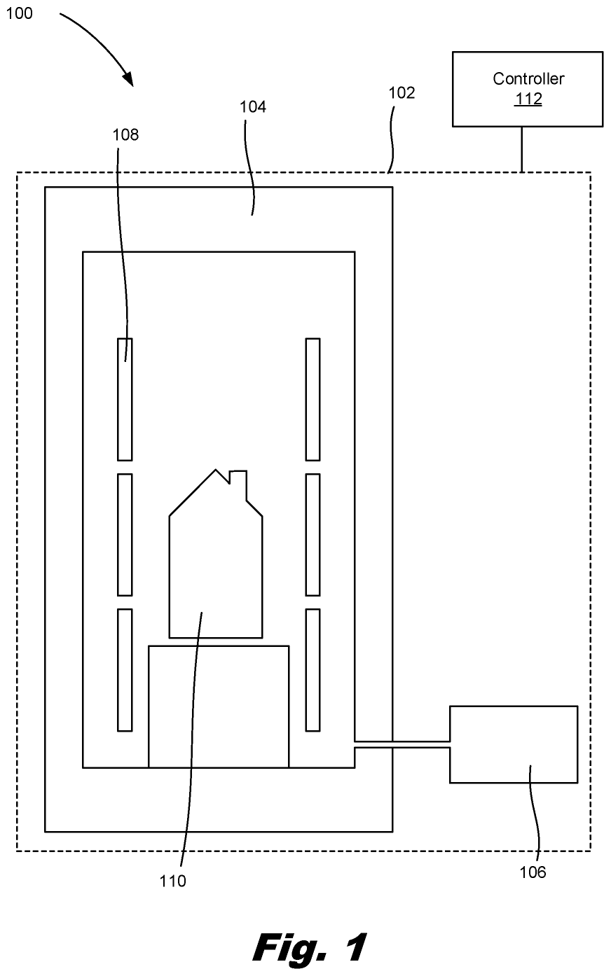

Turning now to the figures, FIG. 1 is a diagram of a system (100) for reducing pore density in an additively manufactured 3D steel object (110), according to an example of the principles described herein. The system (100) as described herein reduces the pore density and increases the strength of the 3D steel object (110) by exposing the 3D steel object (110) to elevated pressures and temperatures. That is, within the pressure vessel (104), the 3D steel object (110) may be exposed to isostatic pressures of between 100 and 200 megapascals (MPa) and temperatures of between 1100 and 1400 degrees Celsius (C).

The 3D steel object (110) may be additively manufactured in any number of ways. For example, the 3D steel object (110) may be additively manufactured via a binding agent-based system. Some experiments have found additively manufactured 3D steel objects (110) have a reduced fatigue strength due to a porosity of the additively manufactured 3D steel objects (110) and due to the formation of grains in the 3D steel object (110). However, the present system (100), by applying isostatic pressure and heat, reduced the pore density and size within the additively manufactured 3D steel object (110) and increased strengths were observed.

The 3D steel object (110) may be formed of a variety of types of steel. In one particular example the 3D steel object (110) is formed of SS17-4PH steel. However, the 3D steel object (110) may be formed through other additive manufacturing operations and of different types of steel.

As described above, the system (100) reduces the pore density of the 3D steel object (110) by exposing the 3D steel object (110) to elevated pressures and temperatures. Accordingly, the system (100) includes an isostatic pressing system (102) that includes a pressure vessel (104) to receive an additively manufactured 3D steel object (110).

Within the pressure vessel (104), the 3D steel object (110) is subjected to isostatic gas pressure. Isostatic pressure is pressure that is uniformly applied across all surfaces of the 3D steel object (110). Hydrostatic pressure provides such uniform application via a fluid or gas introduced into the pressure vessel (104). In such an example, the hot isostatic pressing system (102) includes a pressure source (106) that pumps and pressurizes a fluid or gas to generate the isostatic pressure. As described above, the pressure within the pressure vessel (104) may be between 100 MPa and 200 MPa. The pressure within the pressure vessel (104) may be selected based on any number of criteria including the characteristics of the 3D steel object (110) itself or of the additive manufacturing process. For example, different binding agents, build materials, and additive manufacturing parameters may impact the quantity and size of pores within the 3D steel object (110) matrix. The characteristics of the pores may trigger particular pressure and heater settings that would result in reduced pore density. Accordingly, different pressure and heat settings may be implemented to reduce the openness of the pores by a determined amount or to reduce the pore size and density to a target value.

As another example, the pressure may be set based on target mechanical properties. For example, an object may be exposed to a high number of fatigue cycles during use such that a robust fatigue strength is desired. In other examples, the object may not be exposed to high fatigue during its life such that a reduced fatigue strength is acceptable. As such, a reduced pressure may be generated within the pressure vessel (104).

In an example, the pressure source (106) introduces argon gas into the pressure vessel (104) to provide the isostatic pressure. An inert gas such as argon is used such that the 3D steel object (110) does not chemically react. In some examples, the pressure vessel (104) may include a lid or other opening through which the additively manufactured 3D steel object (110) may be introduced into the pressure vessel (104).

The hot isostatic pressing system (102) also includes a heater (108) to heat the 3D steel object (110) while in the pressure vessel (104). That is, the volume within the pressure vessel (104) is heated, causing the pressure inside the pressure vessel (104) to increase. The heater (108) may heat the 3D steel object (110) to between 1100 and 1400 degrees Celsius. The heater may include conductive plates coupled to an electrical source. As depicted in FIG. 1, the heater (108) may be disposed within the pressure vessel. The application of pressure and temperature reduce the pore size within the 3D metal object (110).

That is, the metal material is compressed by the applied pressure in all directions (x, y and z) at high temperature. At temperatures close to solidus temperature (0.8 Tsolidus), the metal is soft and easy to compress. This facilitates reduction in size of large pores or complete elimination by pore closure.

The system (100) also includes a controller (112) to control the hot isostatic pressing system (102). Specifically, the controller (112) determines the characteristics of the 3D steel object (110) and determines the temperature and pressure settings for the isostatic pressing operation as well as a duration for isostatically treating the 3D steel object (110).

That is, as described above, various properties of the 3D steel object (110) define the pore density and size within the object material matrix. Examples of such characteristics include a binding agent that is used in additively manufacturing the 3D steel object (110), a powder material used in additively manufacturing the 3D steel object (110), and a powder size of the powder material. That is, each of these characteristics may impact the formation and characteristics of pores within the 3D steel object (110). The characteristics of the pores may impact the temperature and pressure settings to be used. For example, larger pores may trigger higher pressure and temperature treatment for a longer period of time as compared to smaller pores. The powder material, and more particularly the particle size of the powder material, may also impact the pore size. Accordingly, the controller (112) receives this information, for example via user input or via metadata associated with a file that describes the 3D steel object (110) and determines what pressure, temperature, and time settings to implement in the isostatic pressing operation. As such, the controller (112) activates the pressure source (106) and the heater (108) to apply the determined pressure and temperature to the 3D steel object (110) based on the determined characteristics of the 3D steel object (110).

As described above, target properties may also be used to select the particular temperature and pressure settings to implement. As such, a combination of target properties and raw materials may be used to select particular temperature and pressure settings for the hot isostatic pressing system (102). While particular reference is made to particular criteria by which temperature and pressure settings are selected, other criteria may be used in determining these settings.

Moreover, while temperature and pressure settings are particularly described, the controller (112) may determine other settings as well. For example, the controller (112) may determine the duration of isostatic pressing. For example, the duration of isostatic pressing may be between 1 and 4 hours. As with the temperature and pressure settings, the duration setting may be based on any of the afore-mentioned criteria.

The controller (112) may include various hardware components, which may include a processor and memory. The processor may include the hardware architecture to retrieve executable code from the memory and execute the executable code. As specific examples, the controller (112) as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller (112) cause the controller (112) to implement at least the functionality of isostatically pressing a 3D steel object (110).

A test was performed to confirm the results that isostatically treating a 3D steel object (110) did in fact increase the strength of a 3D steel object (110). Specifically, the test indicated that the system (100) as described herein led to reduced porosity in binding-agent printed SS17-4PH steel bars. Specifically, porosity of binding-agent printed steel bars initially were observed to have a porosity of 4.1±0.22%. Using the system (100) and methods described herein, the porosity of SS17-4PH steel bars was reduced to 2.37±0.46% and 2.76±0.57% for H1150 and H900 ageing treatments, respectively. The porosity was further reduced to 1.3±0.06% and 0.84±0.09%, respectively, after treatment in the hot isostatic pressing system (102) as described herein.

Additionally, while binding-agent printing may result in 3D steel objects with pores having an average diameter of less than 30 microns, treating the 3D steel objects (110) with the system (100) described herein may result in pores having an average diameter of less than 10 microns. This reduction in overall porosity as well as size of the pores resulted in fatigue strength measurements of 500-540 MPa, which is comparable to fatigue strength achieved in non-additively manufactured objects. Furthermore, the grain growth during isostatic pressing was impeded, possibly due to pinning of the grain boundary by the pores present along the grain boundaries. As such, despite previous expectations where it was believed isostatic pressing would not increase the fatigue strength given the characteristics of additively manufactured object pores, the 3D steel objects (110) produced by a BJP and treated with the system (100) described herein had similar yield strength and ultimate tensile strength as compared to non-additively manufactured counterparts.

That is, high cycle fatigue of alloys depends on the crack initiation life i.e., time spent in crack initiation rather than propagation. The fatigue crack initiation is relatively easier in materials with pores because of higher stress intensity factor (Kₜ) around them. Stress at pore corner increases multiplicatively by a factor of Kₜ with applied stress (σ_{∞}). The value of Kₜ is determined by the size and shape of the pores, which in turn is a factor controlling the fatigue crack initiation life. That is, a higher Kₜ leads to easy crack initiation and poor fatigue properties. Accordingly, given the characteristics of the pores and the grain growth that propagated therefrom in other additively manufactured steel objects (110), HIP was shown to be ineffective to increase the strength of the 3D steel object (110). However, as indicated in the graphs depicted below, increased strength was observed. Moreover, the isostatic pressing changed the shape of the pores, such that they were made more spherical, and therefore less likely to be an origin of a fatigue crack. That is, the reduced pore size and reduced percentage of pores provides better fatigue strength.

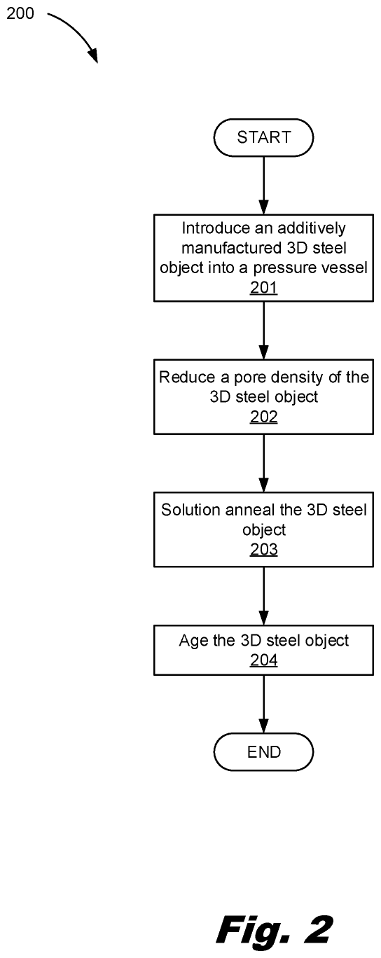

FIG. 2 is a flow chart of a method (200) for reducing pore density in an additively manufactured 3D steel object (FIG. 1, 110), according to an example of the principles described herein. According to the method (200), an additively manufactured 3D steel object (FIG. 1, 110) is introduced (block 201) into a pressure vessel (FIG. 1, 104). As described above, the pressure vessel (FIG. 1, 104) may have a closeable lid or some other feature wherein the pressure vessel (FIG. 1, 104) may be opened and the 3D steel object (FIG. 1, 110) inserted therein.

According to the method (200) a pore density within the 3D steel object (FIG. 1, 110) is reduced (block 202). This may be done by applying hydrostatic pressure on the 3D steel object (FIG. 1, 110) uniformly in all directions. Specifically, the pressure source (FIG. 1, 106) may pump a gas into the pressure vessel (FIG. 1, 104) and may pressurize the gas. In an example, the hydrostatic pressure may be between 100 and 200 megapascals (MPa).

While under pressure, the 3D steel object (FIG. 1, 110) is heated in the pressure vessel (FIG. 1, 104) to a first temperature for a first duration of time. Doing so further increases the pressure which further reduces (block 202) pore density. In an example, this first temperature may be between 1100 and 1400 C and the first duration of time may be between 1 and 4 hours.

In an example, the 3D steel object (FIG. 1, 110) may be solution annealed (block 203). In solution annealing (block 203), the 3D steel object (FIG. 1, 110) is heated to a predetermined temperature and held at that temperature long enough to cause constituents to enter into a solid solution. Solution annealing (block 203) dissolves precipitates present in the 3D steel object (FIG. 1, 110) and transforms the material at the solution annealing temperature into a single-phase structure. In some examples, the temperature may be between 1000 and 1050 degrees Celsius and the duration may be for more than 30 minutes. The heated 3D steel object (FIG. 1, 110) is then quenched to room temperature to hold these constituents in solution. That is, at the end of the solution annealing process, the 3D steel object (FIG. 1, 110) is quenched down to room temperature to avoid any precipitation from occurring during cooling through lower temperature ranges.

In an example, the 3D steel object (FIG. 1, 110) may be aged (block 204). Ageing includes maintaining the 3D steel object (FIG. 1, 110) at a second temperature for a second duration of time. In one aging operation, the second temperature is greater than 400 degrees Celsius and the second duration of time is greater than 1 hour. In another aging operation, the second temperature is 620 degrees Celsius and the second duration of time is 4 hours. As with other processes, the characteristics of the aging operation may be selected based on properties of the raw materials of the 3D steel object (FIG. 1, 110), properties of the additive manufacturing operations, and/or target parameters for the finished 3D steel object (FIG. 1, 110). That is, the duration and temperature settings for the aging operation may be selected based on the afore-mentioned properties.

As described herein, the method (200) reduces the pore density of an additively manufactured 3D steel object (FIG. 1, 110). The method also reduces the pore size of the 3D steel object (FIG. 1, 110). In one test, the average size of the pores was reduced from 30 microns to 10 microns, a reduction of 66%. Table 1 below depicts the measured properties of various steel specimens, including 1) those formed in non-additive manufacturing operations (CM), 2) those formed with selective laser melting (SLM) operations, 3) those additively manufactured with BJP and wherein aging post processing operations (A1 and A2) but no hot isostatic pressing operation (HIP were performed, and 4) those additively manufactured with BJP where aging and isostatic pressing post processing operations were performed. In the tests, the A1 aging operation includes heating the specimen to 480 degrees Celsius for 1 hour and the A2 aging operation includes heating the specimen to 620 degrees Celsius for 4 hours.

TABLE 1

| | | | Ultimate | | | |
|---|---|---|---|---|---|---|
| | | | Tensile | Yield | Elongation | Fatigue |
| | Post Fab. | Porosity | Strength | Strength | to Failure | Strength |
| Batch | Treatment | (%) | (MPa) | (MPa) | (%) | (MPa) |
| CM | A1 | — | 1381 ± 9 | 1173 ± 33 | 16 ± 3.6 | 550-600 |
| CM | A2 | — | 962 ± 0.3 | 737 ± 4 | 18 ± 5 | 500-550 |
| SLM | A1 | 0.55-0.73 | 1150-1410 | 1020-1250 | 2.8-11 | <150 |
| Batch 1 | A1 | 4.1 ± 0.22 | 1166 ± 25 | 1044 ± 31 | 4.2 ± 1.9 | 325 |
| Batch 2 | A1 | 2.37 ± 0.46 | 1294 ± 11 | 1079 ± 88 | 8.3 ± 1.5 | 275 |
| Batch 2 | A2 | 2.76 ± 0.57 | 1001 ± 29 | 760 ± 71 | 5.6 ± 2.5 | 250 |
| Batch 3 | HIP + A1 | 1.30 ± 0.06 | 1407 ± 7 | 1228 ± 43 | 15.5 ± 3.3 | 475 |
| Batch 3 | HIP + A2 | 0.84 ± 0.09 | 1009 ± 8 | 843 ± 27 | 20.6 ± 7.7 | 500-540 |

As depicted in Table 1, the average yield and ultimate tensile strength for 3D steel objects (FIG. 1, 110) with both isostatic pressing and aging treatments are higher than the CM specimens. Furthermore, the elongation to failure for the 3D steel objects (FIG. 1, 110) formed with both isostatic pressing and aging treatments are also comparable to the CM specimens.

Table 1 also lists the fatigue strength (for 10⁷ cycles) obtained from different batches of BJP and CM specimens. The BJP 3D steel objects (FIG. 1, 110) with both hot isostatic pressing post processing operations and the A2 aging treatment show fatigue strength in the range 500-540 MPa, which is similar to those of CM specimens (e.g., 500-550 MPa). Further, the fatigue strength of BJP 3D steel objects (FIG. 1, 110) with both hot isostatic pressing and the A1 aging treatment is 475 MPa. Which is also higher than those manufactured via other additive manufacturing, i.e., laser powder bed fusion (LPBF), electron beam powder bed fusion (E-PBF).

As described above, the test demonstrated the utility of hot isostatic pressing in additively manufactured, and specifically binding-agent printed, 3D steel objects (FIG. 1, 110). That is, some experiments have found pores of objects formed with additive manufacturing techniques have a higher Kₜ value and have a large size in comparison to binder jet printed objects. In order to reduce the size of these pores, an unoptimized hot isostatic treatment with respect to temperature and time had been implemented. However, this isostatic treatment resulted in increased coarsening of the microstructures, which compromised the strength of those objects formed with other additive manufacturing processes. The present specification reduces the porosity by isostatically treating the 3D steel object (FIG. 1, 110) while avoiding a significant coarsening of the microstructure.

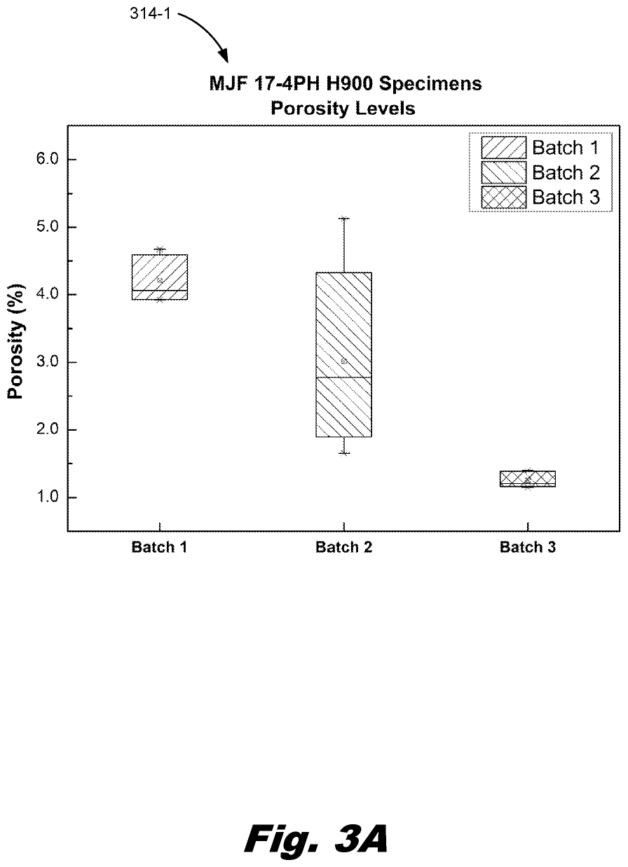

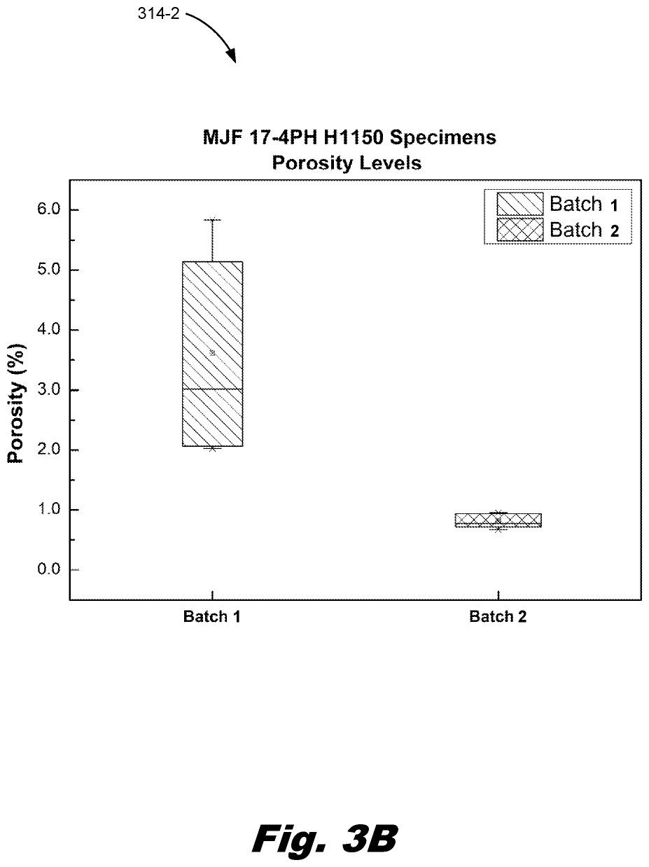

FIGS. 3A and 3B are graphs (314) depicting a porosity of 3D steel objects (FIG. 1, 110) treated as described in the method, according to an example of the principles described herein. Specifically, FIG. 3A illustrates a graph (314-1) depicting the porosity of three SS17-4PH steel batches treated with a first aging treatment. A third batch, was also treated with isostatic pressure and heat as described herein, while a first and second batch were not. As can be seen from FIG. 3A, isostatic pressing results in a reduced porosity percentage in the third batch.

FIG. 3B illustrates a graph (314-2) depicting the porosity of two SS17-4PH steel batches treated with a second aging treatment. A second batch was treated with isostatic pressure and heat as described herein, while a first batch was not. As can be seen from FIG. 3B, isostatic pressing results in a reduced porosity percentage in the second batch.

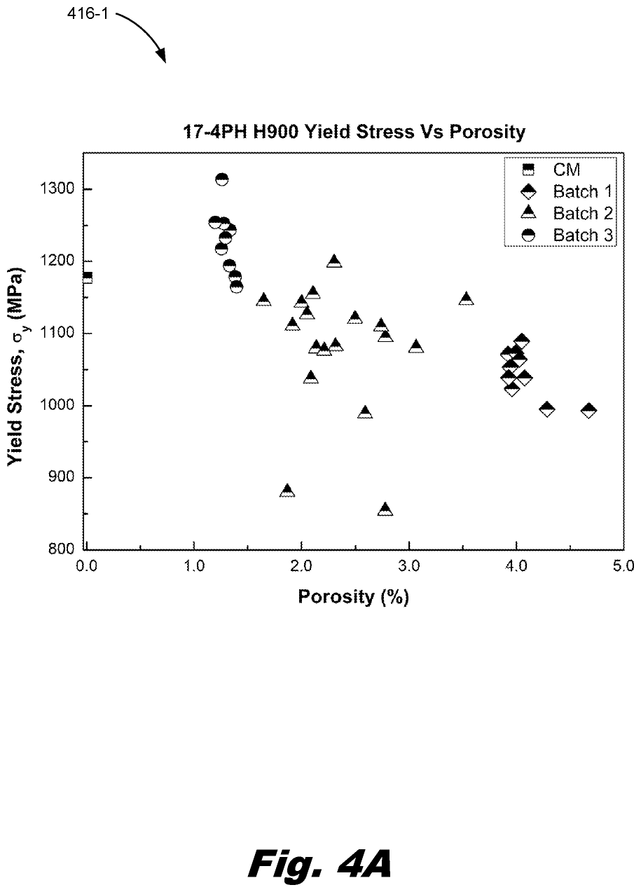

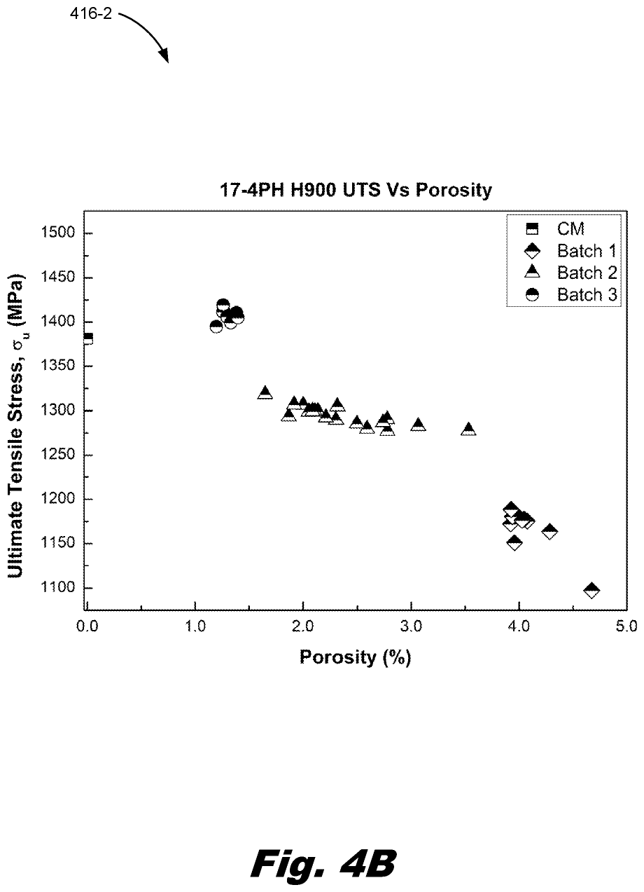

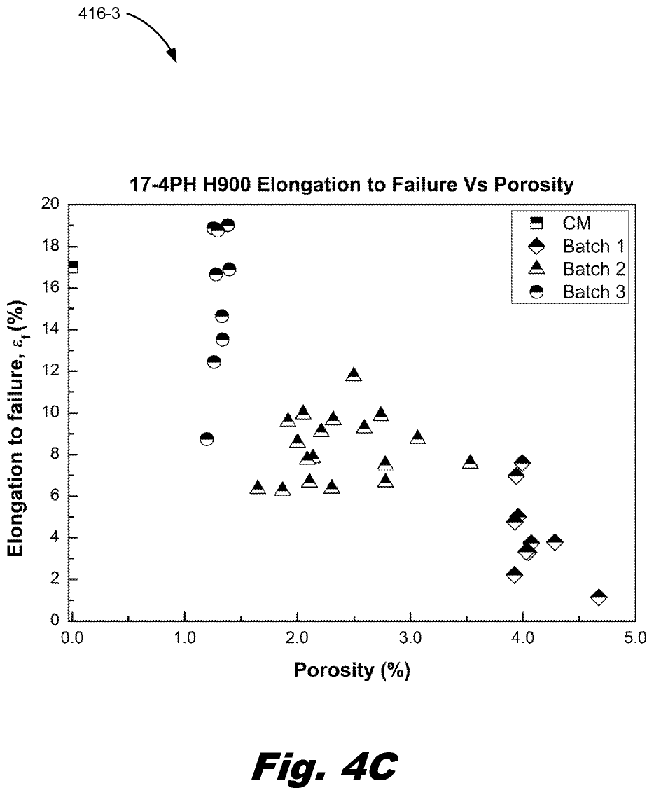

FIGS. 4A-4C are graphs (416) depicting physical properties of 3D steel objects (FIG. 1, 110) treated as described in the method, according to an example of the principles described herein. Specifically, FIGS. 4A-4C depict material properties of steel batches treated with a first aging treatment.

FIG. 4A illustrates a graph (416-1) that depicts the yield strength as a function of porosity for various 3D steel objects (FIG. 1, 110). As can be seen in FIG. 4A, batches that were isostatically pressed, Batch 3, results in less porosity and a higher yield strength than those batches, Batches 1 and 2, additively manufactured but not isostatically treated.

FIG. 4B illustrates a graph (416-2) that depicts the ultimate tensile strength as a function of porosity for various 3D steel objects (FIG. 1, 110). As can be seen in FIG. 4B, the test batches that were isostatically treated, Batch 3, had reduced porosity and a higher ultimate tensile strength than those test batches, Batch 1 and 2, additively manufactured but not isostatically treated.

FIG. 4C illustrates a graph (416-3) that depicts the elongation to failure as a function of porosity for various 3D steel objects (FIG. 1, 110). As can be seen in FIG. 4C, test batches that were isostatically pressed, Batch 3, had less porosity and a higher elongation to failure than those batches, Batch 1 and 2, additively manufactured but not isostatically treated.

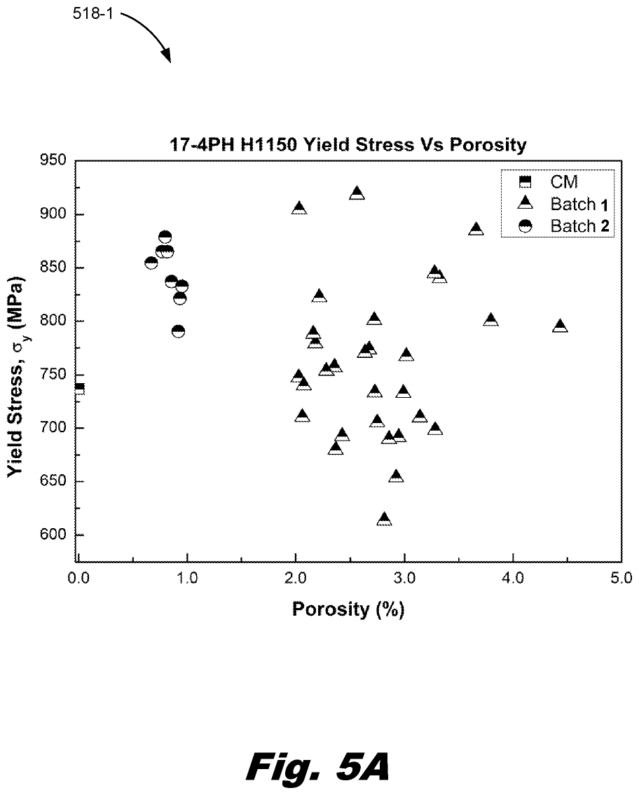

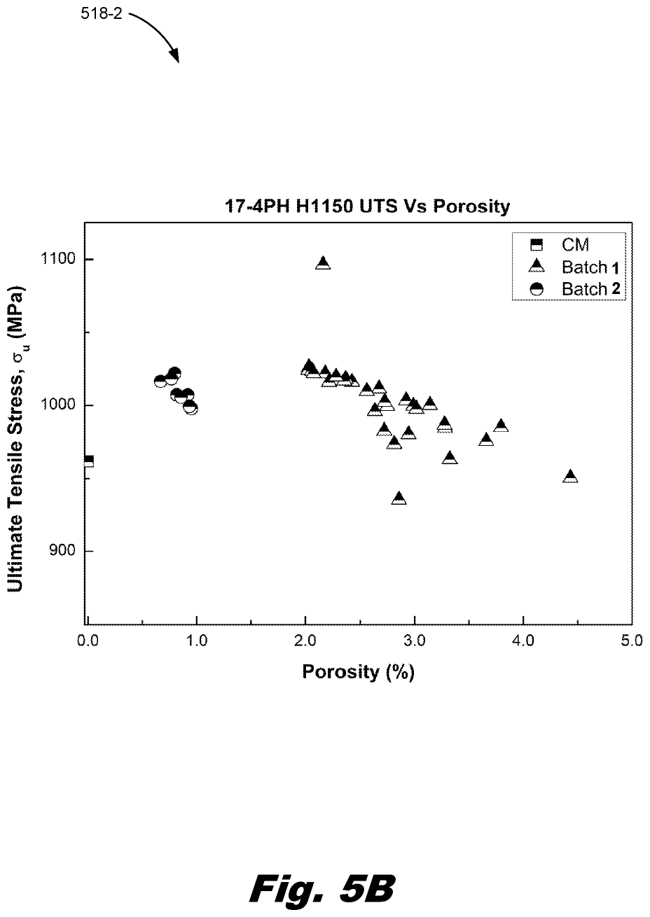

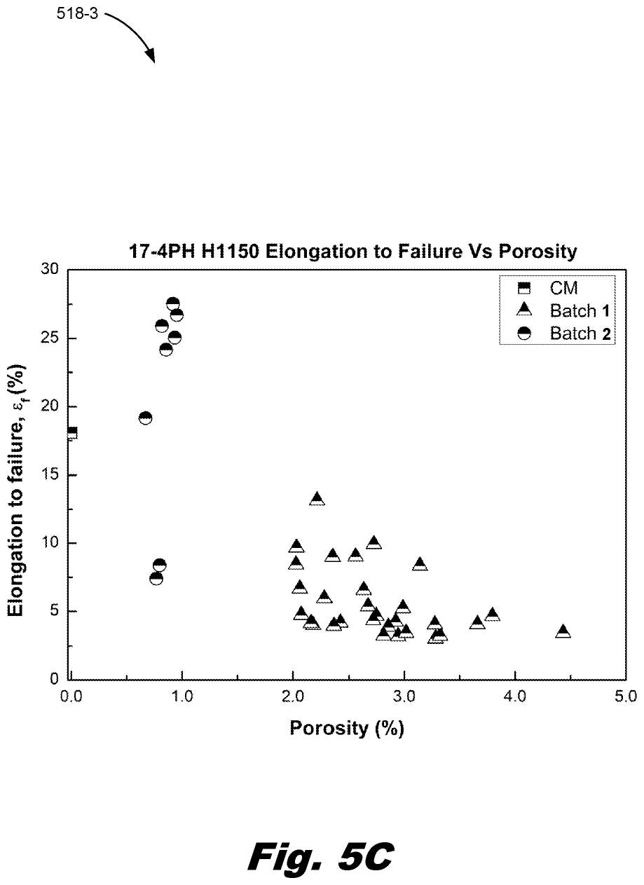

FIGS. 5A-5C are graphs (518) depicting physical properties of 3D steel objects (FIG. 1, 110) treated as described in the method, according to an example of the principles described herein. Specifically, FIGS. 5A-5C depict material properties of steel batches treated with a second aging treatment.

FIG. 5A illustrates a graph (518-1) that depicts the yield strength as a function of porosity for various 3D steel objects (FIG. 1, 110). As can be seen in FIG. 5A, batches that were isostatically pressed, Batch 2, had less porosity and a higher yield strength than the batch, Batch 1, additively manufactured but not isostatically treated.

FIG. 5B illustrates a graph (518-2) that depicts the ultimate tensile strength as a function of porosity for various 3D steel objects (FIG. 1, 110). As can be seen in FIG. 5B, the batches that were isostatically pressed, Batch 2, had less porosity and a similar ultimate tensile strength than the batch, Batch 1, additively manufactured but not isostatically treated.

FIG. 5C illustrates a graph (518-3) that depicts the elongation to failure as a function of porosity for various 3D steel objects (FIG. 1, 110). As can be seen in FIG. 5C, the batch that was isostatically pressed, Batch 2, had less porosity and a higher elongation to failure than the batch, Batch 1, additively manufactured but not isostatically treated.

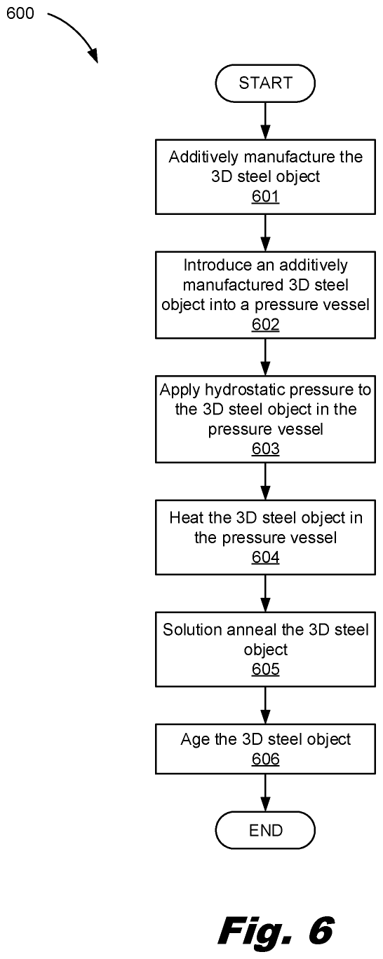

FIG. 6 is a flow chart of a method (600) for reducing pore density in an additively manufactured 3D steel object (FIG. 1, 110), according to an example of the principles described herein. According to the method (600), the 3D steel object (FIG. 1, 110) is additively manufactured. This may include layer-wise forming a green 3D steel object using a metallic powder build material and a binding agent. This may include the sequential deposition of a layer of metallic build material and depositing a binding agent across the layer of build material in a pattern to form a slice of a 3D object. These deposition operations may include sequential activation, per slice, of a build material distributor and an agent distribution system and the scanning carriages to which they may be coupled so that each distributes a respective composition across the surface. That is, the build material distributor is arranged to dispense a build material layer-by-layer onto the bed to additively form the 3D object.

Once the 3D steel object (FIG. 1, 110) is fully formed, the binding agent is activated or cured by heating the 3D steel object (FIG. 1, 110). Heating to form the cured green part may take place at a temperature that is capable of activating (or curing) the binder of the binding agent, but that does not thermally decompose the binder. The cured green object has enough mechanical strength such that it is able to withstand extraction from the BJP and placed into a sintering oven. The green 3D steel object (FIG. 1, 110) is then sintered to form a solidified 3D steel object (FIG. 1, 110). Specifically, the binding agent is removed and the temperature is further raised such that sintering of the powder metal particles occurs to form a 3D object.

The 3D steel object (FIG. 1, 110) is then introduced (block 602) into a pressure vessel (FIG. 1, 104) where the pore density is reduced by applying (block 603) hydrostatic pressure against the 3D steel object (FIG. 1, 110) in the pressure vessel (FIG. 1, 104) and heating (block 604) the 3D steel object in the pressure vessel (FIG. 1, 104). These operations may be performed as described above in connection with FIG. 2.

In an example, the 3D steel object (FIG. 1, 110) may be solution annealed (block 605) and aged (block 606) as described above in connection with FIG. 2.

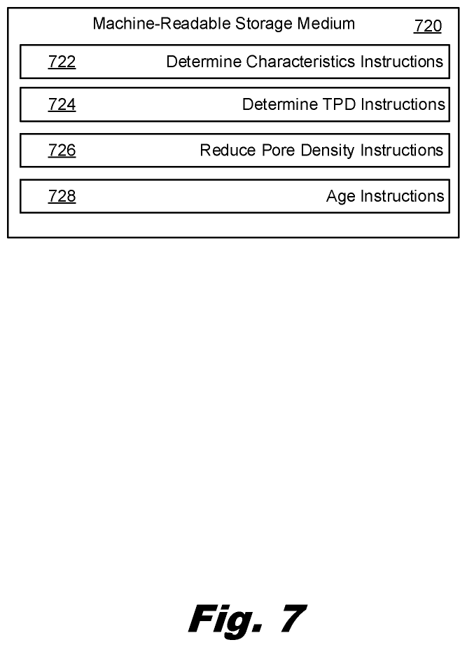

FIG. 7 depicts a non-transitory machine-readable storage medium (720) for reducing pore density in an additively manufactured 3D steel object (FIG. 1, 110), according to an example of the principles described herein. To achieve its desired functionality, a controller (FIG. 1, 112) includes various hardware components. Specifically, the controller (FIG. 1, 112) includes a processor and a machine-readable storage medium (720). The machine-readable storage medium (720) is communicatively coupled to the processor. The machine-readable storage medium (720) includes a number of instructions (722, 724, 726, 728) for performing a designated function. The machine-readable storage medium (720) causes the processor to execute the designated function of the instructions (722, 724, 726, 728).

Referring to FIG. 7, determine characteristics instructions (722), when executed by the processor, cause the processor to determine characteristics of the 3D steel object (FIG. 1, 110). Determine TPD instructions (724) when executed by the processor, may cause the processor to, determine a temperature, pressure, and duration (TPD) for isostatically treating the 3D steel object (FIG. 1, 110). Reduce pore density instructions (726), when executed by the processor, may cause the processor to reduce pore density in the 3D steel object (FIG. 1, 110) by activating a pressure source (FIG. 1, 106) to apply hydrostatic pressure to the 3D steel object (FIG. 1, 110) in a pressure vessel (FIG. 1, 104) and activate a heater (FIG. 1, 108) to heat the 3D steel object (FIG. 1, 110) in the pressure vessel (FIG. 1, 104) to a first temperature for a first duration of time. Age instructions (728), when executed by the processor, may cause the processor to age the 3D steel object (FIG. 1, 110) at a second temperature for a second duration of time.

Accordingly, such systems and methods 1) provide an additively manufactured steel object with increased tensile strength, ductility, and fatigue strength as compared to other additively manufactured steel objects; 2) have equiaxed grains free from residual stress; and 3) quickly produce such additively manufactured steel objects.

What is claimed is:

1. A system, comprising:
a hot isostatic pressing system, comprising:
a pressure vessel to receive an additively manufactured three-dimensional (3D) steel object;
a pressure source to apply isostatic pressure to the 3D steel object disposed therein; and
a heater to heat the 3D steel object while in the pressure vessel; and
a controller to:
determine characteristics of the 3D steel object;
determine, a temperature, pressure, and duration for isostatically treating the 3D steel object; and
activate the pressure source and heater to apply a determined pressure and temperature to the 3D steel object based on determined characteristics of the 3D steel object.

2. The system of claim 1, wherein the 3D steel object comprises SS17-4PH steel.

3. The system of claim 1, wherein characteristics are selected from the group consisting of:
a binding agent used in additively manufacturing the 3D steel object;
a powder material used in additively manufacturing the 3D steel object; and
a powder size of the powder material.

4. The system of claim 1, wherein the pressure source introduces argon gas into the pressure vessel to apply the isostatic pressure.

5. A method, comprising:
introducing an additively manufactured three-dimensional (3D) steel object into a pressure vessel;
reducing a pore density of the 3D steel object by:
applying hydrostatic pressure to the 3D steel object in the pressure vessel; and
heating the 3D steel object in the pressure vessel to a first temperature for a first duration of time;
solution annealing the 3D steel object; and
aging the 3D steel object at a second temperature for a second duration of time.

6. The method of claim 5, further comprising additively manufacturing the 3D steel object.

7. The method of claim 6, wherein additively manufacturing the 3D steel object comprises:
layer-wise forming a green 3D steel object using metallic powder build material and a binding agent; and
sintering the green 3D steel object to form a solidified 3D steel object.

8. The method of claim 5, wherein:
hydrostatic pressure of between 100 and 200 megapascals (MPa) is applied to the 3D steel object;
the first temperature is between 1100 and 1400 degrees Celsius; and
the first duration of time is between 2 and 4 hours.

9. The method of claim 5, wherein:
the second temperature is greater than 400 degrees Celsius; and
the second duration of time is greater than 1 hour.

10. The method of claim 5, wherein:
the second temperature is 650 degrees Celsius; and
the second duration of time is 4 hours.

11. The method of claim 5, wherein solution annealing the 3D steel object comprises:
heating the 3D steel object to a temperature between 1000 and 1050 degrees Celsius for more than 30 minutes; and
quenching a heated 3D steel object.

12. The method of claim 5, wherein the 3D steel object comprises SS17-4PH steel.

13. A non-transitory machine-readable storage medium encoded with instructions executable by a processor of an electronic device, the machine-readable storage medium comprising instructions to, when executed by the processor, cause the processor to:
determine characteristics of a three-dimensional (3D) steel object;
determine, a temperature, pressure, and duration for isostatically treating the 3D steel object;
reduce pore density in the 3D steel object by:
activate a pressure source to apply hydrostatic pressure to the 3D steel object in a pressure vessel; and
activate a heater to heat the 3D steel object in the pressure vessel to a first temperature for a first duration of time; and
age the 3D steel object at a second temperature for a second duration of time.

14. The non-transitory machine-readable storage medium of claim 13, further comprising instructions to, when executed by the processor, cause the processor to reduce a pore size of the 3D steel object.

15. The non-transitory machine-readable storage medium of claim 14, wherein a pore size is reduced by 66%.
